(19) United States
(12) Patent Application Publication
(10) Pub. No.: US 2003/0191893 A1
(43) Pub. Date: Oct. 9, 2003

(54) Method, system, and apparatus for efficient trace cache

(76) Inventors: John Alan Miller, Portland, OR (US); Michael J. StClair, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/119,867

(22) Filed: Apr. 9, 2002

(51) Int. Cl. G06F 12/00

(52) U.S. Cl. 711/118; 711/154

(57) ABSTRACT

The invention supports the detection and/or healing of a non-optimal trace.

### BACKGROUND

The disclosure is related to trace caches, specifically, to revise a trace to improve efficiency.

In a computer or computing system, a cache stores information in order to decrease data retrieval times for a processor. Some examples of computing systems are a personal digital assistant, internet tablet, and a cellular phone. The cache stores specific subsets of information in high-speed memory. A few examples of information are instructions, addresses, and data. When a processor requests a piece of information, the system checks the cache first to see if the information is stored within the cache. If so, the processor can retrieve the information much faster than if the data was stored in other computer readable media, such as, random access memory, a hard drive, compact disc read-only memory (CD ROM), or a floppy disk.

One particular type of cache is a trace cache. A trace cache is utilized for building, caching and delivering traces to a processor. A trace is one or more instructions that sometimes are distinguishable from one another by their first segment, commonly referred to as a “trace head”. A few problems arise with the formation of a trace cache and result in a non-optimal trace. For example, a non-optimal trace may result from a system reset condition or general interrupt request may prevent the completion of a trace and results in an interrupted trace build. As a result of the interrupted trace build, another trace needs to be formed from scratch. Thus, the formation of another trace decreases the efficiency of the trace cache. Another example of a non-optimal trace is the absence of a branch at the end of a trace. This may indicate an incomplete trace and requires a time consuming search for another trace.

### BRIEF DESCRIPTION OF THE DRAWINGS

Claimed subject matter is particularly and distinctly pointed out in the concluding portion of the specification. The claimed subject matter, however, both as to organization and method of operation, together with objects, features, and advantages thereof, may best be understood by reference to the following detailed description when read with the accompanying drawings in which:

FIG. 1 is a diagram of a trace cache utilized by an embodiment.

FIG. 2 is a diagram of a trace cache utilized by an embodiment.

FIG. 3 is a diagram of a trace cache utilized by an embodiment.

FIG. 4 is a diagram of a trace cache as utilized by the prior art.

FIG. 5 is a diagram of a trace cache utilized by an embodiment.

FIG. 6 is a m e t hod utilized by an embodiment.

FIG. 7 is a system utilized by an embodiment.

### DETAILED DESCRIPTION

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, components and circuits have not been described in detail so as not to obscure the claimed subject matter.

An area of current technological development relates to improving processor efficiency and operating bandwidth. As previously described, there are problems that arise during the formation of a trace cache that result in a non-optimal trace. A non-optimal trace may be incomplete, interrupted, or inefficient. The trace cache's efficiency suffers from non-optimal traces because of the duplicative task of building another trace and/or locating and moving to another trace. However, the efficiency of the trace cache may be improved, for example, by implementing a method and/or an apparatus to heal the non-optimal trace. Thus, the healed trace improves efficiency of the trace cache because the healed trace eliminates the duplicative task of building another trace and/or eliminates the process of locating and moving to another trace.

In one aspect, the claimed subject matter identifies non-optimal traces, such as, inefficient, interrupted, and incomplete traces. In another aspect, the claimed subject matter increases the trace cache's efficiency by healing the non-optimal trace. In yet another aspect, the claimed subject matter identifies and heals non-optimal traces.

As previously discussed, healing the non-optimal trace improves the efficiency of the trace cache. In contrast, the prior art formation of another trace from scratch to replace the non-optimal trace decreases the efficiency of the trace cache because of the additional build of the new trace and/or the process of moving to another trace. Various methods and embodiments will be further discussed in the following figures.

Although the scope of the claimed subject matter is not limited in this respect, it is noted that some embodiments may further include subject matter from the following U.S. Pat. Nos., 6,018,786 and 6,170,038 titled “TRACE BASED INSTRUCTION CACHING”, by R. Krick, G. Hinton, C. Lee, M. Upton, and D. Sager.

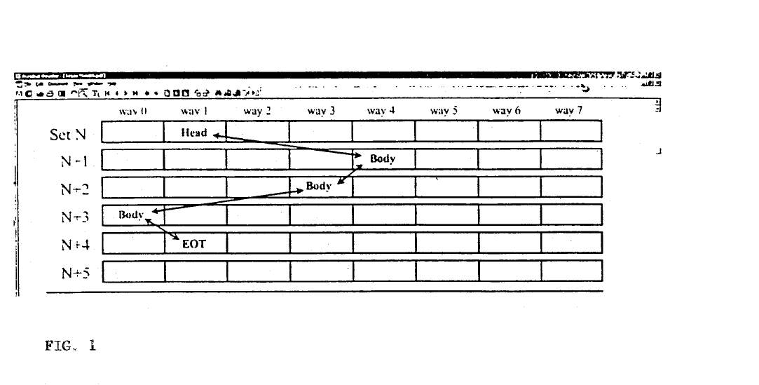

FIG. 1 is a diagram of a trace cache utilized by an embodiment. The diagram illustrates a trace cache with a plurality of ways, 0-7, and a plurality of sets. In one embodiment, there are four sets. In another embodiment, there are eight sets. In still another embodiment, there are two hundred fifty six sets. The claimed subject matter is not limited to the number of previously discussed number of sets. One skilled in the art appreciates that the claimed subject matter may support a wide range of sets.

Typically, a cache is defined by a plurality of ways and sets. As one example, the diagram illustrates a trace cache with a trace that begins with a head in a location defined by set N and way 1. The trace continues with a first body in a location defined by set N+1 and way 4 that allows for a bi-directional or double link back to the head. Likewise, the trace continues with a second body in a location defined by set N+2 and way 3 that allows for a bi-directional or double link back to the first body. The trace continues with a third body in a location defined by set N+3 and way 0 that allows for a bi-directional or double link back to the second body. Finally, the trace ends with an End of Trace (EOT) in a location defined by way 1. This trace is a normal trace and is complete because it was not interrupted during the build mode and has bi-directional links between the various portions of the segments and has at least one body. In one embodiment, the trace cache is coupled to a processor of a computing system. In another embodiment, the trace cache is integrated within a processor of a computing system. In yet another embodiment, the trace cache is integrated within a processor.

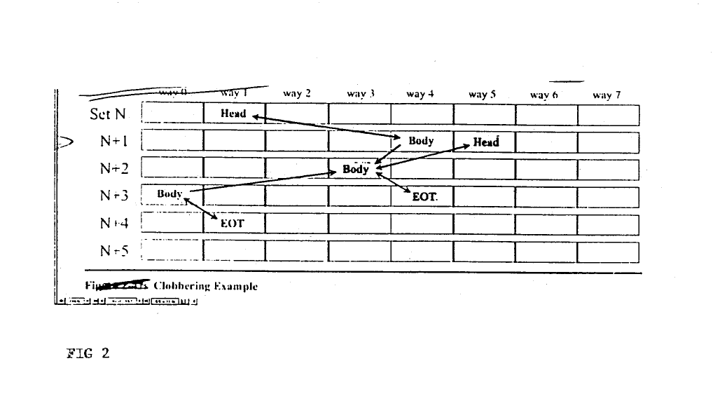

FIG. 2 is a diagram of a trace cache utilized by an embodiment. The diagram illustrates a trace that is commonly referred to as a clobber. For example, the trace is non-optimal because a body segment of the trace at location defined by N+1 and way 4 does not have a bi-directional or double link to a body segment of the trace at location defined by N+2 and way 3. One reason for this trace to be “clobbered” is an original trace was overwritten and at least one segment or node of the trace is missing, thus, resulting in a missing bi-directional or double link between the body at location defined by N+1 and way 4 to the body segment of the trace at location defined by N+2 and way 3.

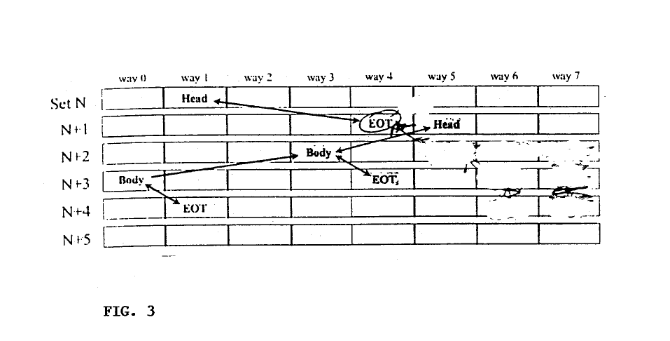

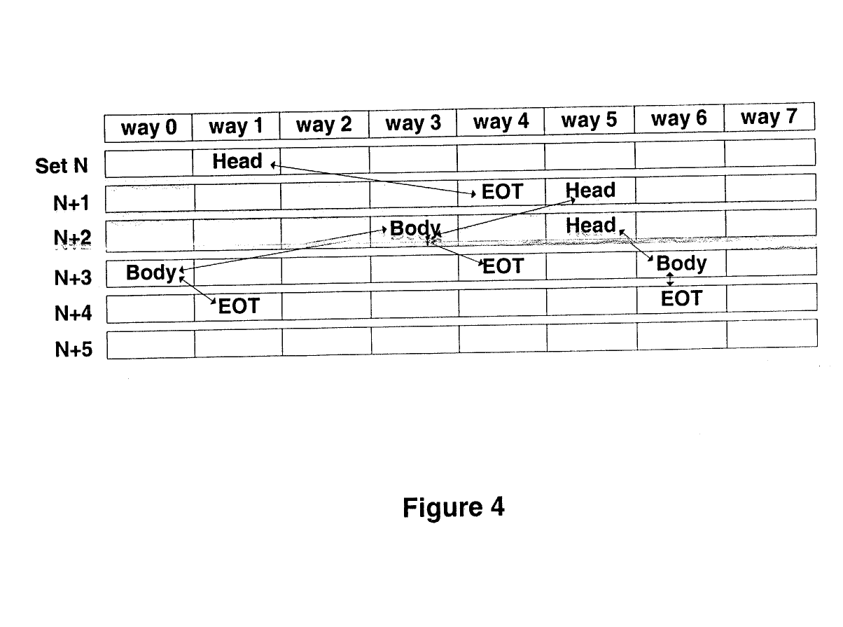

FIG. 3 is a diagram of a trace cache utilized by an embodiment. The diagram illustrates a first attempt at healing the trace diagram from FIG. 2. For example, the trace diagram in FIG. 3 has changed the body segment at location defined by N+1 and way 4 to an end of trace (EOT) segment. Proceeding on with the healing of the trace, FIG. 4 illustrates a diagram of a trace cache as utilized by the prior art. The prior art diagram of FIG. 4 starts a new trace with a head segment defined by location N+2 and way 5 coupled to a plurality of body segments at locations N+3 and way 6 and N+4 and way 6, respectively. The prior art does not effectively heal the trace because a new trace has been built and requires additional processing time to move from the original trace to the new trace.

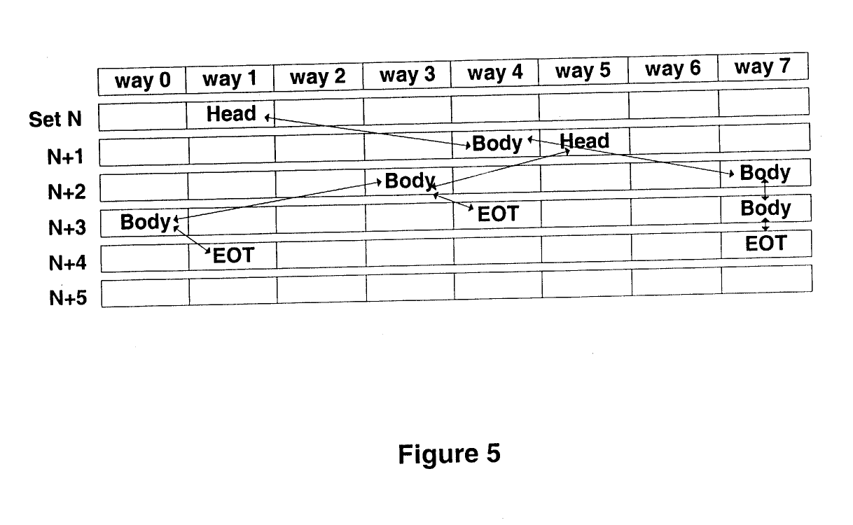

In contrast, FIG. 5 illustrates one example of an effective healing of the trace. First, the trace begins the healing by changing the end of trace segment at location defined by N+1 and way 4 to a body. Next, the healing adds a plurality of body segments defined at locations N+2, N+3 and way 7 and culminates with an end of trace segment at location defined by N+4 and way 7. Thus, the healed trace did not result in a building of a new trace and does not require additional processing time from moving from the original trace to the new trace. Therefore, the original trace was maintained and repaired, and results in improved efficiency by precluding the additional building of another trace and moving from the original trace to the new trace.

The claimed subject matter is not limited to the previously described trace at the locations defined by way 7 and N+2 through N+4. For example, the altered trace may begin at any unused location.

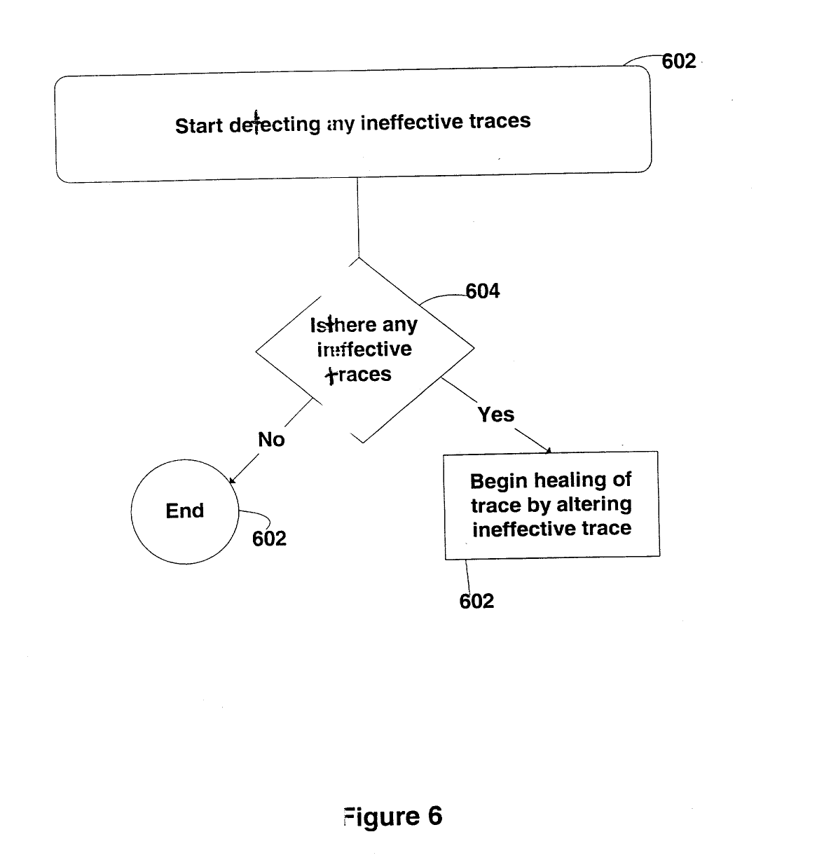

FIG. 6 illustrates a method utilized by an embodiment. The method includes, but is not limited to, the following blocks 602, 604, 606, and 608. The method has a first block 602 that detects any non-optimal traces. For example, the block 602 detects non-optimal traces by looking for an absence of bi-directional or double links between two body segments of a trace. Another example is the block 602 detects non-optimal traces by looking for a trace that does not contain at least one body segment. In yet another example, the block 602 detects non-optimal traces by looking for a trace that has been clobbered. In still yet another example, the block 602 detects a non-optimal trace if there is an absence of a branch at the end of a trace. Continuing on, block 604 determines whether block 602 has detected any non-optimal traces. If not, the method ends at block 606. If so, block 608 begins the healing of the non-optimal traces. One example of healing a non-optimal trace is adding segments to the non-optimal trace. In another example of healing is the alteration of at least one segment of the trace to a different segment type, such as, changing an end of trace segment to a body segment. In yet another example of healing is combining both the alteration of at least one segment of the trace to a different segment type with the addition of segments to the non-optimal trace.

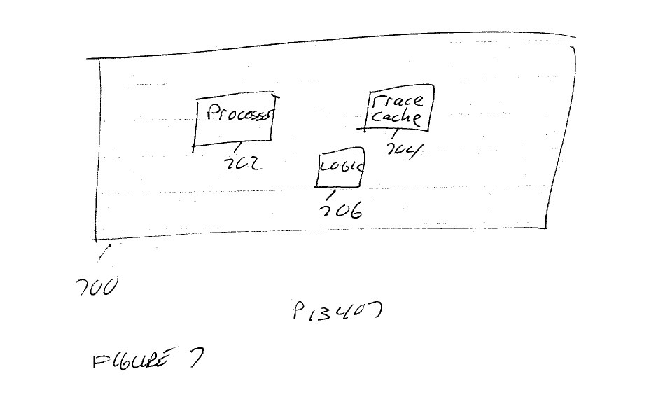

FIG. 7 depicts a system utilized by an embodiment. The system comprises a processor 702, a trace cache 704, and a logic 706. In one embodiment, the trace cache supports a healing of non-optimal traces as depicted in the previous figures. The trace cache 704 builds, caches, and delivers the traces to the processor. In one embodiment, the trace cache and logic are integrated within the processor. Alternatively, in another embodiment, the trace cache 704 is coupled to the processor and the logic 706 is integrated within the trace cache. In still another embodiment, the trace cache 704 is coupled to the processor and the logic 706 is integrated within the processor.

While certain features of the claimed subject matter have been illustrated and detailed herein, many modifications, substitutions, changes and equivalents will now occur to those skilled in the art. It is, therefore, to be understood that the appended claims are intended to cover all such modifications and changes as fall within the true spirit of the claimed subject matter.

1. A method comprising:
reading a trace with a plurality of segments from a cache;
detecting whether the trace is non-optimal; and
healing the trace if the trace is non-optimal.

2. The method of claim 1 wherein healing the trace comprises altering the trace by adding at least one new segment to the trace.

3. The method of claim 1 wherein healing the trace comprises altering the trace by changing at least one segment of the trace.

4. The method of claim 1 wherein healing the trace comprises:
altering the trace by changing at least one segment of the trace; and
altering the trace by adding at least one segment to the trace.

5. The method of claim 1, wherein the cache is a trace cache.

6. The method of claim 1, wherein the trace comprises:
a head segment;
at least one body segment; and
an end of trace segment.

7. The method of claim 1, wherein the trace cache comprises a plurality of locations defined by a plurality of sets and a plurality of ways.

8. The method of claim 6 wherein the plurality of sets is six and the plurality of ways is eight.

9. An apparatus comprising:
a trace cache to store a plurality of traces, each trace to have a plurality of segments; and
a logic, coupled to the trace cache, to heal at least one of the plurality of traces if the trace is non-optimal.

10. The apparatus of claim 9 wherein to heal the trace comprises to alter at least one segment of the trace.

11. The apparatus of claim 9 wherein to heal the trace comprises to alter at least one segment of the trace and to add at least one segment to the trace.

12. The apparatus of claim 9 wherein to heal the trace comprises to add at least one segment to the trace.

13. A system comprising:
a processor;
a trace cache, coupled to the processor, to store a plurality of traces, each trace to have a plurality of segments; and
a logic, coupled to the trace cache and processor, to heal at least one of the plurality of traces if the trace is non-optimal.

14. The system of claim 13 wherein to heal the trace comprises to alter at least one segment of the trace.

15. The system of claim 13 wherein to heal the trace comprises to alter at least one segment of the trace and to add at least one segment to the trace.

16. The system of claim 13 wherein to heal the trace comprises to add at least one segment to the trace.
